(19) United States
(12) Patent Application Publication
(10) Pub. No.: US 2005/0152143 A1
(43) Pub. Date: Jul. 14, 2005

(54) Lighting device utilizing mixed light emitting diodes

(76) Inventors: Den-Hua Lee, Hsinchu (TW); Chu-Feng Tsai, Taichung (TW); Wei Fang, Taipei (TW)

Correspondence Address: BIRCH STEWART KOLASCH & BIRCH, PO BOX 747, FALLS CHURCH, VA, 22040-0747, US

(21) Appl. No.: 10/853,163

(22) Filed: May 26, 2004

(30) Foreign Application Priority Data
Jan. 8, 2004 (TW) 093100421

(51) Int. Cl. F21V 21/00

(52) U.S. Cl. 362/249; 362/230

(57) ABSTRACT

A lighting device with mixed LEDs for cultivating young plants. The lighting device comprises a lamp set, a plurality of light modules, a waveform generating module and a control module. The light modules can be selectively disposed on the lamp set. Each light module comprises a plurality of mixed light emitting diodes with various arrangements. The waveform generating module is electrically connected to the light module mounted in the lamp. The control module houses a waveform database comprising preset waveform data for different light modules, such that the control module can directs the waveform generating module to provide power of different waveforms according to each light module mounted on the lamp set and corresponding plants.

### BACKGROUND OF THE INVENTION

1. Field of the Invention

The present invention relates to a lighting device utilizing mixed light emitting diodes, and in particular to a lighting device with different light module and a preset waveform database for different young plants.

2. Description of the Related Art

Tubular fluorescent lamps (TFLs) are widely used as artificial light sources for plant tissue culture. TFLs, however, suffer reom excess heat generation, rapid decay, fixed light quality, short life span and flickering. Conversely, light emitting diodes (LEDs) generate no excess heat, such that LEDs can be arranged very close to the cultured plant, thus reducing spave required for culturing. In addition, LEDs have the advantages of long life span and low power consumption. Therefore, research in culturing plants with LEDs is prolific. In 1992, Hoenecke, et al. successfully cultured vegetables with high intensity red LEDs (Hoenecke, M. E., R. J. Bula, and T. W. Tibbitts, 1992, Importance of ‘Blue’ photon levels for lettuce seedlings grown under red-light-emitting diodes, HortScience 27(5): 427-430). In 1993, blue LEDs were successfully developed. In 1996, Okamoto et al. used high intensity red and blue LEDs to culture plants, with a quantum ratio of 2:1 for red light/blue light (Okamoto, K., T. Yanagi and S. Takita, 1996, Development of plant growth apparatus using blue and red LED as artificial light source, Acta Hort., 440: 111-116). Also in 1996, Yanagi et al. used blue LEDs (170 μmol/m²/s) to culture lettuce (Yanagi, T., K. Okamoto and S. Takita, 1996, Effects of blue, red and blue/red lights of two different PPF levels on growth and morphogenesis of lettuce plants, Acta Hort, 440: 117-122). The dry weight of the cultured lettuce using pure blue light was less than that of the lettuce cultured by pure red light or red/blue light. Nevertheless, the cultured lettuce was short and healthy.

All the prior research took place on a small scale, while the present invention is provided for the purpose of mass production. Furthermore, conventional lighting devices in labs only provide light with some preset wavelengths and waveforms, but do not correspond to different species of plants. Hence, there is a need for a better lighting device for mass production of different plants.

### SUMMARY OF THE INVENTION

Accordingly, an object of the invention is to provide a lighting device with different light modules for different plants, such that the light module can be rapidly configured, thus shortening preparation time, when cultivated plants in labs are rotated.

Another object of the invention is to provide a lighting device, providing light with optimized waveforms for predetermined plants through a control module including a preset database. The illumination for plants can be optimized, thus shortening the culture time.

The present invention provides a lighting device with mixed LEDs comprising a track, lamp sets, different light modules, a driver and a control module. The lamp sets are detachably mounted on the electric track. The light modules can be selectively disposed on the lamp sets. Each light module comprises a plurality of mixed light emitting diodes with various arrangements. The driver comprises waveform generating modules electrically connected to the light module through a bus line. The control module houses as a waveform database comprising preset waveform data for different light modules. The control module directs the waveform generating modules to provide power of different waveforms according to each light module mounted on the lamp set and corresponding plants.

The light emitting diodes comprise infrared, red, orange, yellow, green, blue, white, ultraviolet or other LEDs. The control module can be a microcontroller or a computer.

Furthermore, the waveform generating modules control the frequency, voltage, current and trigger time of the output waveforms according to the preset waveform data. The waveforms comprise pulse, sinusoidal, square, and saw-toothed or combinations thereof.

The present invention provides another lighting device with mixed LEDs comprising a lamp set, a plurality of light modules, a waveform generating module and a control module. The light modules can be selectively disposed on the lamp set. Each light module comprises a plurality of mixed light emitting diodes with various arrangements. The waveform generating module is electrically connected to the light module mounted in the lamp. The control module houses a waveform database comprising preset waveform data for different light modules, such that the control module can enable the waveform generating module to provide power of different waveforms according to each light module mounted on the lamp set and corresponding plants.

The light emitting diodes comprise infrared, red, orange, yellow, green, blue, white, ultraviolet or other LEDs.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1A is a block diagram of a lighting device of the present invention.

FIG. 1B is a perspective view of a plant-growing bench equipped with the lighting device of the present invention.

FIG. 2 is a perspective view of a lamp set of the present invention.

FIG. 3 shows a light module in FIG. 2.

FIGS. 4A˜4E show five possible waveforms provided by the waveform generating module.

FIG. 5A is a block diagram of another lighting device of the present invention.

FIG. 5B is a schematic view of the lighting device in second embodiment.

### DETAILED DESCRIPTION OF THE INVENTION

### First Embodiment

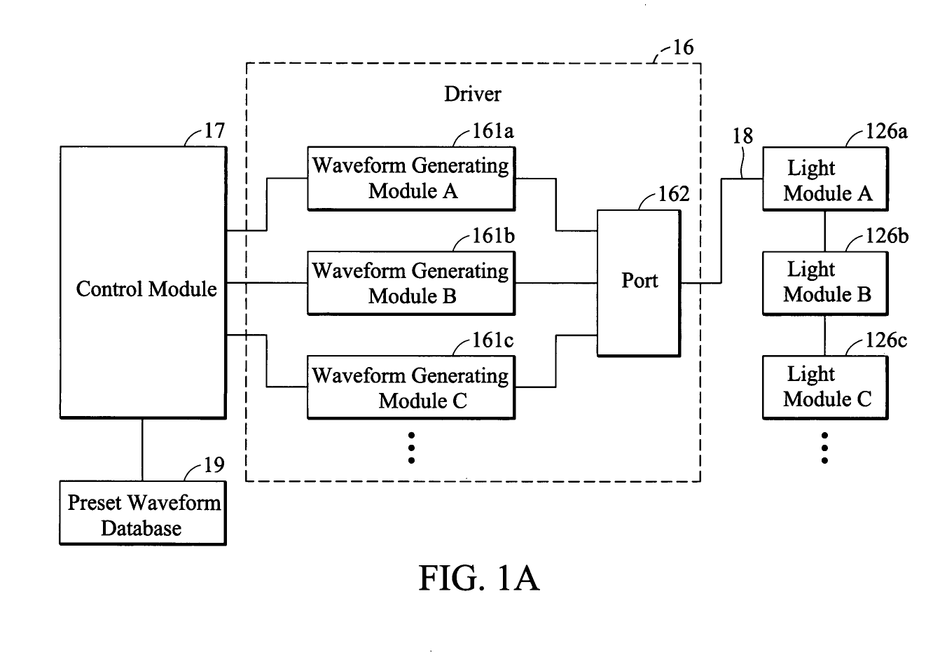

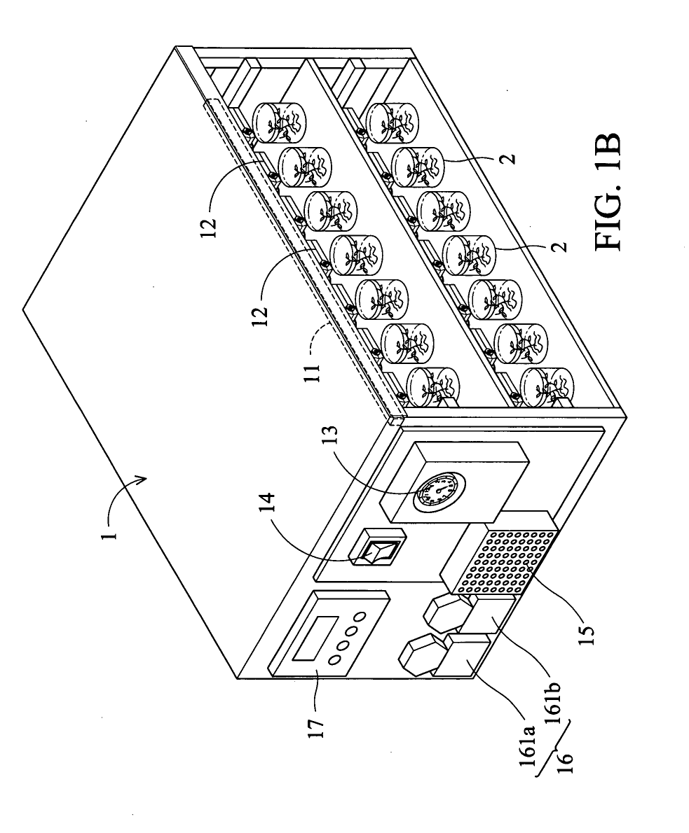

FIG. 1A is a block diagram of a lighting device of the present invention. In FIG. 1, the lighting device comprises a control module 17, a driver 16 and a plurality of light modules 126a˜126c. The light modules 126a˜126c are connected in series and then connected to a port 162 of the driver 16 through a bus line 18. The driver 16 comprises a plurality of waveform generating modules 161a˜161c electrically connected to the light modules 126a˜126c through the port 162. The control module 17 houses a waveform database 19 comprising preset waveform data (not shown) for different light modules 126a˜126c. The control module 17 enables the waveform generating modules 161a˜161c to provide different power waveforms for each corresponding light module 126a˜126c.

Referring to FIG. 1B, a plant-growing bench 1 using the lighting devices of the present invention can be partitioned into a plurality of layers. At least one track 11 mounts on the ceiling of each layer, and a plurality of lamp sets 12 are movably disposed on the tracks 11. Cultured plantlets 2 are provided in tissue culture vessels under the lamp sets 12. Furthermore, a timer 13, switch 14, AC/DC converter 15, driver 16 and control module 17 are mounted on a sideboard of the plant-growing bench 1. In order to simplify the drawing, FIG. 1B shows only two waveform generating modules 161a, 161b of the driver 16.

In FIGS. 1A and 1B, the AC/DC converter 15 supplies DC power for the waveform generating modules 161a and 161b of the driver 16, which converts the waveform of input DC power for the light modules 126a˜126c mounted on the lamp sets 12 through the port 162 and bus lines 18. The switch 14 is used for manually turning the power on and off. When the power is on, the timer 13 controls the length of the photoperiod. The waveform generating modules 161a˜161c of the driver 16 can adjust the frequency, voltage, current and trigger time of the output waveforms according to the preset waveform data, thereby controlling the light quantity, light quality and lighting cycle of each light module 126a˜126c during the light-period.

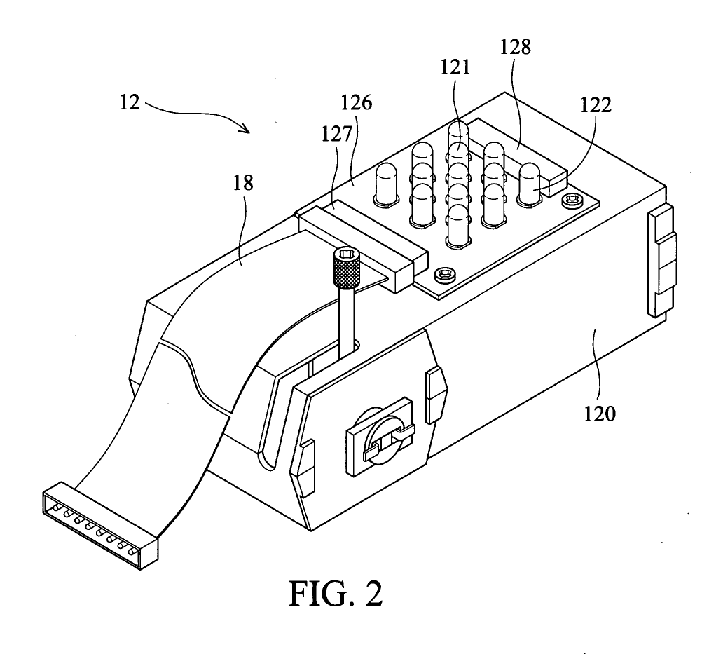

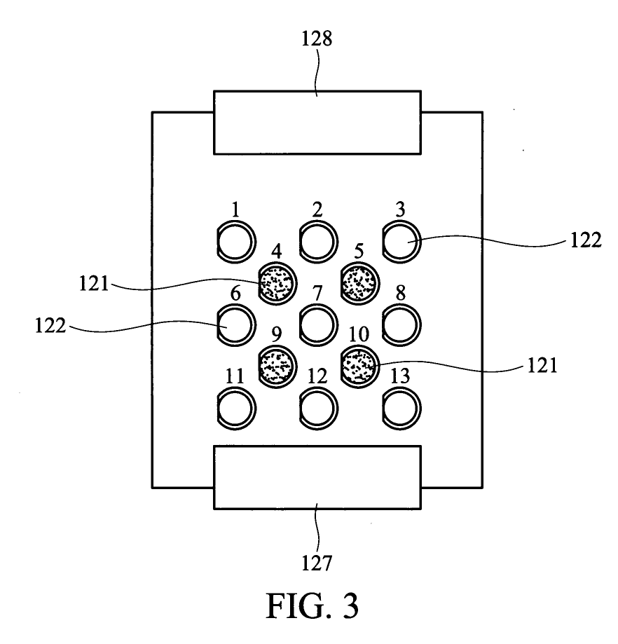

FIG. 2 shows a lamp set 12 of the present invention, and FIG. 3 shows a light module 126 in FIG. 2. In FIGS. 2 and 3, the lamp set 12 has a mounting box 120, and a light module 126 detachably mounted on the box 120. Two LEDs 121 and 122 of different wavelength are arranged in rows on the light module 126, the invention, however, is not limited to this arrangement. The LEDs 121, 122 can be alternatively mounted thereon or be arranged according to the position number thereof. For example, the LEDs used in FIG. 3 are red LEDs 121 and blue LEDs 122, which are alternatingly arranged. The intervals between the rows of red LEDs 121 are smaller than that of the blue LEDs 122. In this embodiment, the LEDs 121 and 122 at different positions are connected to predetermined pins of the ports 127 and 128. After the light module 126 is connected to the waveform generating modules 161a˜161c by the bus line 18, each LED can emit light with different light quantities, light qualities and lighting cycles.

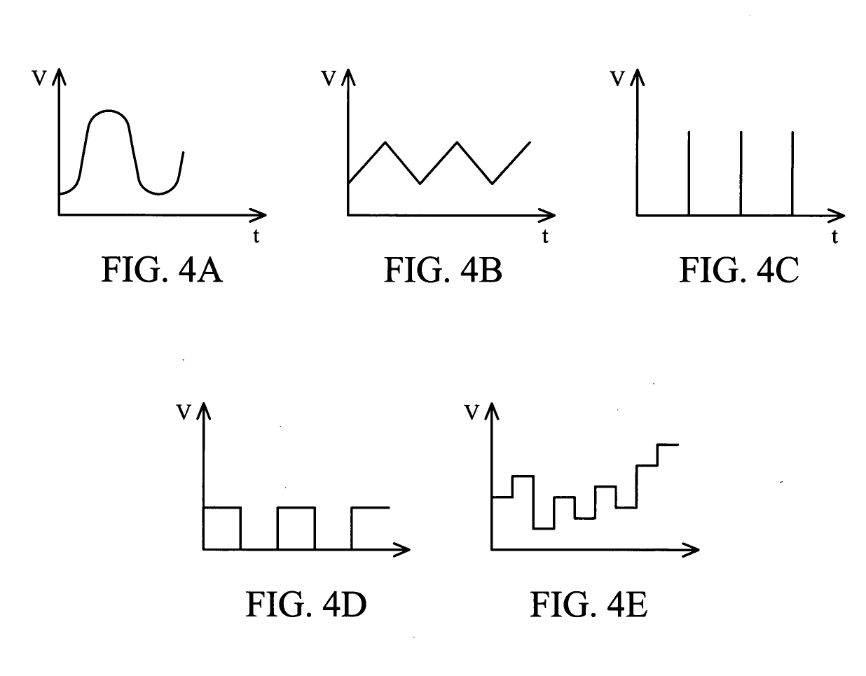

FIGS. 4A-4E shows several waveforms provided by the waveform generating module. The waveforms provided by the waveform generating modules 161a˜161c comprise pulse, sinusoidal, square, saw-toothed or combinations (FIG. 4E) beneficial for specific plant cultures.

Furthermore, different plants require different light sources, such that different LEDs are employed in each light module 126a˜126c correspondingly. The LEDs comprise infrared, red, orange, yellow, green, blue, white, ultraviolet or other LEDs.

In FIG. 1B, the control module 17 can be a microcontroller with preset waveform database 19. The waveform database 19 comprises different waveform data corresponding to different light modules 126a˜126c.

Furthermore, the control module 17 can be a computer communicating with the light modules 126a˜126c through an interface, such as an RS-232 interface. The optimum waveform data for different plants can be stored in a computer, and the waveform database 19 can be updated frequently. When the plant is rotated, the light modules 126a˜126c and the control mode thereof can be easily changed, thus shortening the culture time and facilitating mass-production.

### Second Embodiment

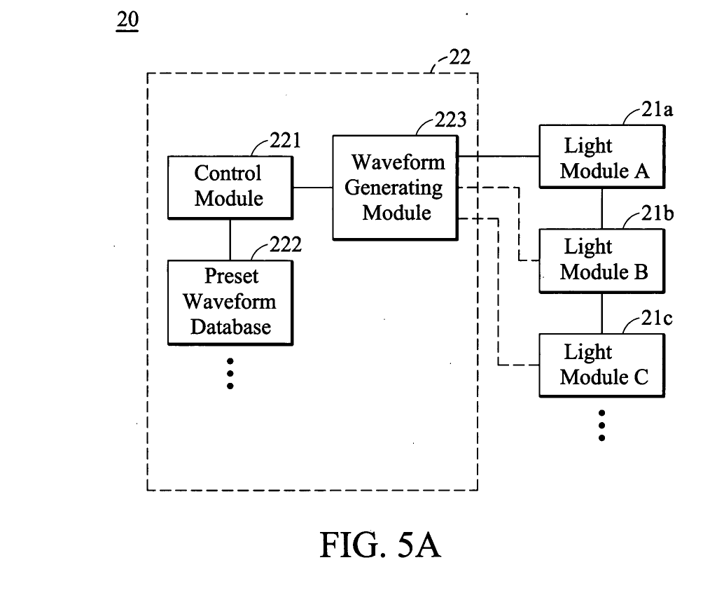

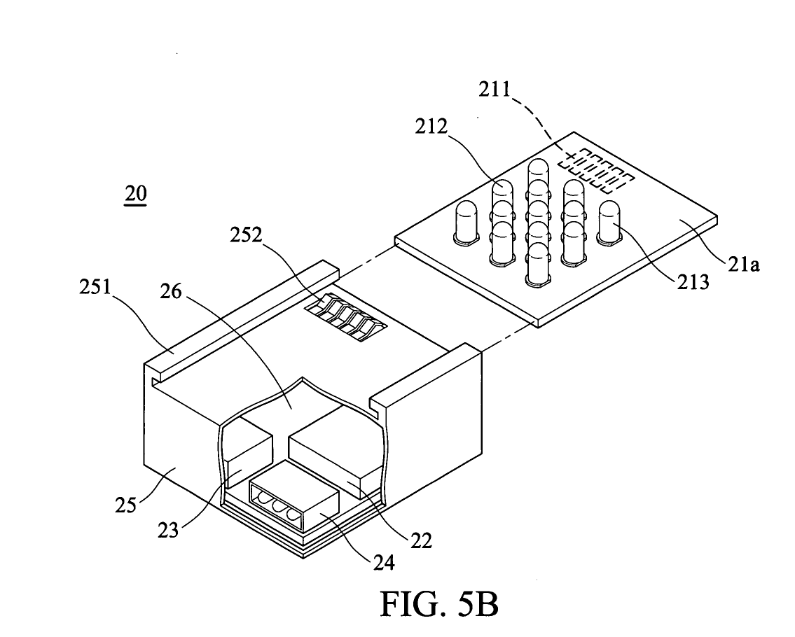

FIG. 5A is a block diagram of another lighting device of the present invention. FIG. 5B is a schematic view of the lighting device in second embodiment. In FIGS. 5A and 5B, the lighting device 20 with mixed LEDs comprises a plurality of light modules 21a˜21c, a waveform generating module 223 and a control module 221. Each light module 21a˜21c comprises a plurality of mixed light emitting diodes with various arrangements. The waveform generating module 223 is electrically connected to the light module 21a˜21c. The control module 221 has a waveform database 222 comprising preset waveform data for different light modules 21a˜21c, such that the control module 221 directs the waveform generating module 223 to provide power of different waveforms according to each light module 21a˜21c mounted on the lamp set 25 and corresponding plants.

In FIG. 5B, the power converting module, waveform generating module and control module of the lighting device are integrated in a lamp set 25. The light modules 20 can be selectively disposed on the lamp set 25. The lamp set 25 comprises a PCB 26 therein with a microcontroller 22, power module 23 and port 24. The port 24 receives external AC or DC power, and the power converting module 23 converts external AC or DC power into required DC power for the lighting device 21a.

The microcontroller 22 combines the functions of the control module 221 and the waveform generating module 223 in FIG. 5A, providing power of different waveforms. The light module 21a comprises separated LEDs 212, 213. The light module 21a can be detatchably disposed on the lamp set 25 through the chute 251 and connects the PCB 26 through the gold fingers 252 contacting the metal contacts 211. The LEDs 212 and 213 in the light module 21a can receive power of different waveforms provided by the microcontroller 22.

The lighting device of the present invention is developed for the purpose of mass-production. Users can individually control light quantity, light quality and lighting cycle of each light module via the driver. Therefore, the lighting device is adaptable to culturing various plantlets corresponding to the best growth conditions for each. Furthermore, researchers can use the lighting device to determined the best light quantity and light quality for the growth of various plantlets, and to assess the acceptable lighting cycles for reducing power comsumption and enhancing the photosynthetic efficiency. Furthermore, the modular structure of the light modules of the present invention facilitates rapid assembly and disassembly and are well suited for use in mass production of plants.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. A lighting device, comprising:
a track;
a bus line;
a lamp set detachably mounted on the electric track;
a plurality of light modules selectively disposed on the lamp set, wherein each light module comprises a plurality of mixed light emitting diodes with various arrangements;
a driver with a plurality of waveform generating modules electrically connected to the light module through the bus line; and
a control module including a waveform database comprising preset waveform data for different light modules, wherein the control module directs the waveform generating modules to provide power of different waveforms according to each light module mounted on the lamp set.

2. The lighting device as claimed in claim 1, wherein the light emitting diodes comprise infrared light emitting diodes.

3. The lighting device as claimed in claim 1, wherein the light emitting diodes comprise red light emitting diodes.

4. The lighting device as claimed in claim 1, wherein the light emitting diodes comprise orange light emitting diodes.

5. The lighting device as claimed in claim 1, wherein the light emitting diodes comprise yellow light emitting diodes.

6. The lighting device as claimed in claim 1, wherein the light emitting diodes comprise green light emitting diodes.

7. The lighting device as claimed in claim 1, wherein the light emitting diodes comprise blue light emitting diodes.

8. The lighting device as claimed in claim 1, wherein the light emitting diodes comprise white light emitting diodes.

9. The lighting device as claimed in claim 1, wherein the light emitting diodes comprise ultraviolet light emitting diodes.

10. The lighting device as claimed in claim 1, wherein the control module is a microcontroller.

11. The lighting device as claimed in claim 1, wherein the control module is a computer.

12. The lighting device as claimed in claim 1, wherein the waveform generating modules control frequency, voltage, current and trigger time of the output waveforms according to the preset waveform data.

13. The lighting device as claimed in claim 1, wherein the waveforms comprise pulse waves.

14. The lighting device as claimed in claim 1, wherein the waveforms comprise sinusoidal waves.

15. The lighting device as claimed in claim 1, wherein the waveforms comprise square waves.

16. The lighting device as claimed in claim 1, wherein the waveforms comprise saw-toothed waves.

17. A lighting device, comprising:
a lamp set;
a plurality of light modules selectively disposed on the lamp set, wherein each light module comprises a plurality of mixed light emitting diodes with various arrangements;
a waveform generating module electrically connected to the light module; and
a control module including a waveform database comprising preset waveform data for different light modules, wherein the control module directs the waveform generating modules to provide power of different waveforms according to each light module mounted on the lamp set.

18. The lighting device as claimed in claim 17, wherein the light emitting diodes comprise infrared light emitting diodes.

19. The lighting device as claimed in claim 17, wherein the light emitting diodes comprise red light emitting diodes.

20. The lighting device as claimed in claim 17, wherein the light emitting diodes comprise orange light emitting diodes.

21. The lighting device as claimed in claim 17, wherein the light emitting diodes comprise yellow light emitting diodes.

21. The lighting device as claimed in claim 17, wherein the light emitting diodes comprise green light emitting diodes.

22. The lighting device as claimed in claim 17, wherein the light emitting diodes comprise blue light emitting diodes.

23. The lighting device as claimed in claim 17, wherein the light emitting diodes comprise white light emitting diodes.

24. The lighting device as claimed in claim 17, wherein the light emitting diodes comprise ultraviolet light emitting diodes.

25. The lighting device as claimed in claim 17, wherein the control module is a microcontroller.

26. The lighting device as claimed in claim 17, wherein the waveform generating module controls frequency, voltage, current and trigger time of the output waveforms according to the preset waveform data.

27. The lighting device as claimed in claim 17, wherein the waveforms comprise pulse waves.

28. The lighting device as claimed in claim 17, wherein the waveforms comprise sinusoidal waves.

29. The lighting device as claimed in claim 17, wherein the waveforms comprise square waves.

30. The lighting device as claimed in claim 17, wherein the waveforms comprise saw-toothed waves.
